(19) United States
(12) Patent Application Publication
(10) Pub. No.: US 2015/0010309 A1
(43) Pub. Date: Jan. 8, 2015

(54) System for Use in Remote Controlling Controlled Device

(71) Applicant: Jeenon, LLC, Santa Clara, CA (US)

(72) Inventors: Dongge Li, Xi'an (CN); Wei Wang, Xi'an (CN); Linshu Bai, Xi'an (CN); Changlin Zhou, Xi'an (CN)

(21) Appl. No.: 14/371,383

(22) PCT Filed: Jan. 9, 2013
(86) PCT No.: PCT/CN2013/070284

§ 371 Date: Jul. 9, 2014

(30) Foreign Application Priority Data
Jan. 9, 2012 (CN) CN201210004846.3

(51) Int. Cl. G08C 23/04; H04N 5/44

(52) U.S. Cl. CPC G08C 23/04; H04N 5/44
USPC 398/106

(57) ABSTRACT

An objective of the present invention is to provide a system for remotely controlling a controlled device. The system comprises 1) emitting means comprising a light-emission source for sending a control signal; 2) detecting means comprising a camera unit for acquiring imaging information of the control signal in the camera unit; 3) computing means for determining location information of the emitting means based on the imaging information acquired by the detecting means; 4) controlling means for determining a control instruction corresponding to the location information so as to control a controlled device connected to the system. Compared with the prior art, a receiving end of the system according to the present invention comprises a computing means for computing location information of the emitting means, and a controlling means that determines a corresponding control instruction based on the location information, which implements remote control of the controlled device and improves the control accuracy, thereby further enhancing the control efficiency and improving the user's control experience.

### TECHNICAL FIELD

The present invention relates to the field of intelligent control technology, and more particularly relates to a technology of remotely controlling a controlled device.

### BACKGROUND OF THE INVENTION

In intelligent control fields such as smart TV, somatosensory interaction, and virtual reality, certain signals (for example, electromagnetic signals, voice signals or optical signals) transmitted by a emitting means are generally detected by a detecting means, so as to perform corresponding control operations, such as turning on or turning off a controlled device. However, when an electromagnetic signal-based system measures an electromagnetic signal, it is easily influenced by an electronic device or terrestrial magnetism existing in the environment; while when a voice signal-based system measures a voice signal, it is easily influenced by environmental noise and other things.

Therefore, in view of the above drawbacks, it is one of imminent problems to be solved by those skilled in the art to determine a system for remotely controlling a controlled device.

### SUMMARY OF THE INVENTION

An objective of the present invention is to provide a system for remotely controlling a controlled device, wherein the system comprises:

emitting means that comprises a light-emitting source for sending a control signal;
detecting means that comprises a camera unit for acquiring imaging information of the control signal in the camera unit;
computing means for determining location information of the emitting means based on the imaging information acquired by the detecting means;
controlling means for determining a control instruction corresponding to the location information so as to control a controlled device connected to the system.

As one of preferred embodiments of the present invention, the detecting means further comprises a mode detecting unit for detecting a working mode of the emitting means; wherein a removable filter is attached in front of the camera unit; the detecting means further comprises an imaging control unit that performs an addition or removing operation to the filter based on the working mode detected by the mode detecting unit.

Preferably, the mode detecting unit comprises an infrared detection sensor for detecting whether the emitting means is working in an infrared mode.

Preferably, the mode detecting unit comprises an environment brightness sensor for detecting an environment brightness of the environment where the emitting means is located, so as to determine a working mode of the emitting means by comparing the environment brightness with a predetermined brightness threshold.

As one of the preferred embodiments of the present invention, the detecting means further comprises a mode detecting unit for detecting a working mode of the emitting means; wherein the detecting means comprises two camera units in front of which an infrared filter and a visible light filter being disposed respectively, and an imaging switching unit for providing, according to the working mode, imaging information of a camera unit, in front of which a filter corresponding to the working mode being disposed to the computing means.

Preferably, the system further comprises a hand gesture identifying means for identifying a hand gesture imaging information of the user as acquired by the camera unit; wherein the controlling means is for determining a control instruction corresponding to the location information and the hand gesture imaging information, so as to control the controlled device connected to the system.

Preferably, the detecting means further comprises an infrared emission unit for emitting an infrared light, so as to acquire hand gesture imaging information of the user.

As one of preferred embodiments of the present invention, the system further comprises an application mode identifying means for determining a current application mode of the system based on a predetermined application mode identifying rule; wherein the controlling means is for determining the control instruction corresponding to the location information and the hand gesture imaging information based on the current application mode, so as to control the controlled device connected to the system.

Preferably, the application mode identifying rule comprises at least one of the following rules:
determining the current application mode based on a working state of the emitting means;
determining the current application mode based on a priority setting of application modes; and
determining the current application mode based on current application information of the system.

As one of preferred embodiments of the present invention, the emitting means comprises a plurality of light-emitting sources for sending control signals; wherein, the computing means is for determining location information of the emitting means based on imaging information of a plurality of control signals corresponding to the plurality of light-emitting sources.

As one of preferred embodiments of the present invention, the system comprises a plurality of emitting means each of which comprises a light-emitting source for sending a control signal, wherein the system further comprises an emission identifying means for identifying the plurality of emitting means.

Preferably, the emission identifying means is for identifying the plurality of emitting means based on the light emitting mode in which the light emission source of each of the plurality of emitting means sends the control signal.

Preferably, the emission identifying means is for identifying the plurality of emitting means based on a motion trace of imaging information corresponding to a light-emitting source of each of the plurality of emitting means.

More preferably, the emission identifying means is further determining priorities of the plurality of emitting means.

As one of the preferred embodiments of the present invention, the system further comprises an auxiliary information acquiring means for acquiring auxiliary information corresponding to the imaging information based on the imaging information of the control signal in the camera unit, wherein the controlling means is for determining the control instruction corresponding to the location information and the auxiliary information, so as to control the controlled device corresponding to the remote control system.

As one of the preferred embodiments of the present invention, the light-emitting mode for the light-emitting source to send the control signal comprises at least one of the following items:
shape;
wavelength;
flicker frequency;
brightness;
brightness distribution.

Preferably, the light-emitting source sends the control signal in an alternative light emitting-mode, wherein the alternative light-emitting mode comprises at least one of the following:
a light-emitting mode with bright-dark alternative variation;
a light-emitting mode with wavelength alternative variation;
a light-emitting mode with light-spot geometrical feature variation.

As one of the preferred embodiments of the present invention, the detecting means comprises a plurality of camera units for acquiring imaging information of the control signal, respectively, wherein the computing means is for determining location information of the emitting means based on the plurality of pieces of imaging information acquired by the plurality of camera units.

As one of the preferred embodiments of the present invention, the system further comprises a feedback means for sending to the emitting means feedback information corresponding to the control signal, wherein the emitting means further comprises:
receiving unit for receiving the feedback information;
executing unit for executing an operation corresponding to the feedback information based on the feedback information.

Preferably, the executing unit is for adjusting the brightness control information of the light-emitting source based on the distance information and/or brightness information of the imaging information included in the feedback information.

As one of the preferred embodiments of the present information, the emitting means further comprises:
instruction acquiring unit for acquiring instruction information that is a user intends to send through the emitting means;
emission control modulation unit for controlling the light-emitting source based on the instruction information to send the control signal at a certain flicker frequency, wherein brightness variation of the control signal corresponds to the instruction information;
   wherein, the camera unit obtains the imaging information and the brightness variation at an exposure frequency at least twice of the flicker frequency;
   wherein, the controlling means is for determining the control instruction based on the location information and the brightness variation so as to control the controlled device corresponding to the remote control system.

Preferably, the emitting means further comprises:

instruction acquiring unit for acquiring instruction information that a user intends to send through the emitting means;
instruction sending unit for sending an instruction signal corresponding to the instruction information based on the instruction information;
wherein, the system further comprises:
instruction receiving means for receiving an instruction signal from the emitting means;
wherein, the controlling means is for determining the control instruction corresponding to the location information and the instruction signal, so as to control the controlled device connected to the system.

As one of the preferred embodiments of the present invention, the emitting means further comprises a switch unit for performing switch control and/or brightness tuning to the light-emitting source, and for performing switch operation and/or brightness tuning on the emitting means based on an operation of the user.

Preferably, the switch unit comprises a touch button switch unit for performing a corresponding operation to the emitting means based on a pressing, or raising, or touching operation of the user.

As one of the preferred embodiments of the present invention, the system further comprises a state switching trigger module for detecting whether a sleep trigger condition for switching the system to the sleep mode is satisfied; wherein the detecting means is for:
when the sleep trigger condition is satisfied, performing a sleep backend operation.

Preferably, the sleep backend operation comprises adjusting an exposure frequency of the camera unit; wherein the detecting means is for:
acquiring imaging information of the control signal in the camera unit based on the adjusted exposure frequency.

Preferably, the state switching trigger means is further for detecting whether a ready trigger condition for switching the system to the ready mode is satisfied; wherein the detecting means is further for entering into a working mode corresponding to the ready trigger condition when the ready trigger condition is satisfied.

Preferably, the location information comprises three-dimensional location information, wherein the computing means further comprises:
light spot detecting unit for detecting an input light spot corresponding to the emitting means based on imaging information acquired by the detecting means;
three-dimensional computing unit for computing three-dimensional location information of the emitting means based on light spot attribute information of the input light spot.

Preferably, the three-dimensional location information comprises three-dimensional rotational location information.

More preferably, the controlling means is for determining the control instruction corresponding to the three-dimensional rotational location information, so as to control the controlled device connected to the system.

Preferably, the emitting means further comprises a spacing unit that is located at an external periphery of the light-emitting source, wherein a part of the spacing unit facing towards the camera unit is in a dark color or covered with a light absorbing material.

As one of the preferred embodiments of the present invention, the controlled device comprises one or more of a TV set, a set-top-box, a mobile device, a gaming machine, or a PC.

Compared with the prior art, a receiving end of the system according to the present invention comprises a computing means for computing location information of the emitting means, and a controlling means that determines a corresponding control instruction based on the location information, which implements remote control of the controlled device and improves the control accuracy, thereby further enhancing the control efficiency and improving the user's control experience.

### BRIEF DESCRIPTION OF THE DRAWINGS

Other features, objectives and advantages of the present invention will become more apparent through reading the detailed description of the non-limiting embodiments with reference to the following accompanying drawings:

FIG. 1 illustrates a system diagram of a system for remotely controlling a controlled device according to one aspect of the present invention;

FIG. 2 illustrates an apparatus diagram of a system for remotely controlling a controlled device according to one preferred embodiment of the present invention;

FIG. 3 illustrates an apparatus diagram of a system for remotely controlling a controlled device according to another preferred embodiment of the present invention;

FIG. 4 illustrates a system diagram of a system for remotely controlling a controlled device according to a further preferred embodiment of the present invention;

FIG. 5 illustrates a system diagram of a system for remotely controlling a controlled device according to a still further preferred embodiment of the present invention;

FIG. 6 illustrates a system diagram of a system for remotely controlling a controlled device according to a yet further preferred embodiment of the present invention;

FIG. 7 illustrates a touch key circuit diagram according to a further preferred embodiment of the present invention.

FIG. 8 shows a structural diagram of a touch button switch unit according to a yet further preferred embodiment of the present invention.

FIG. 9 shows a circuit diagram of a touch button switch unit according to a still further preferred embodiment of the present invention.

Same or like reference numerals in the figures represent the same or like components.

### DETAILED DESCRIPTION OF THE PREFERRED EMBODIMENTS

Hereinafter, the present invention will be further described in detail with reference to the accompanying drawings.

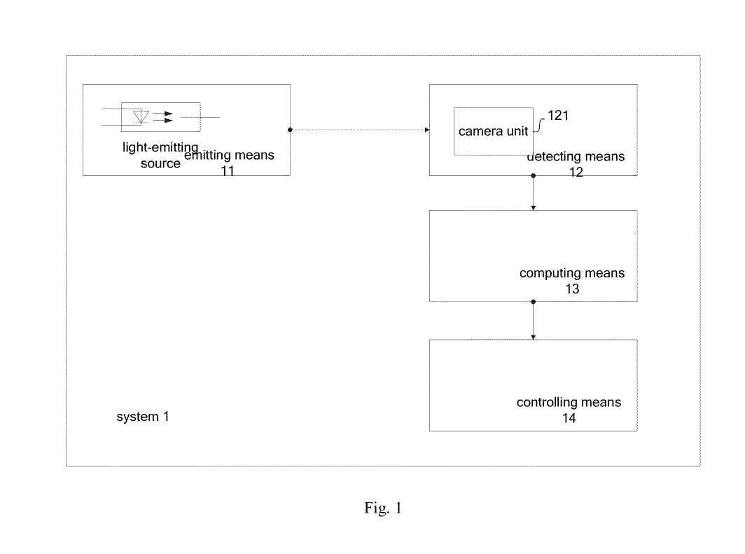

FIG. 1 illustrates a system diagram of a system of remotely controlling a controlled device according to one aspect of the present invention. The system 1 comprises emitting means 11, detecting means 12, computing means 13, and controlling means 14, wherein the detecting means 12 comprises a camera unit 121. Here, the present invention merely takes as an example with a system that comprises the emitting means 11 as the sending end to send a control signal and the detecting means 12 as the receiving end to detect imaging information. Those skilled in the art would appreciate that another embodiment of system 1 may also take the detecting means 12 as the sending end to send a control signal and the emitting means 11 as the receiving end to detect the imaging information, which is incorporated here as a reference.

In this embodiment, the emitting means 11 comprises a light-emitting source for sending a control signal. Specifically, the emitting means 11, for example, may be a remote controller, a joystick, etc. The emitting means 11 is mounted thereon with a light-emitting source that emits light with a certain wavelength as a control signal. The light-emitting source includes, but not limited to, a point light source, a plane light source, a sphere light source, or other arbitrary light source that emits light with a certain wavelength, for example, a LED visible light source, a LED infrared light source, an OLED (organic light-emitting diode) light source, a laser light source, etc. The emitting means 11 may comprise merely one light-emitting source for sending a control signal or may comprise a plurality of light-emitting source for sending a control signal.

This embodiment merely takes LED as an example. Those skilled in the art would appreciate that other existing or other possibly evolving forms of light-emitting sources in the future, particularly, for example, OLED, may be applicable to the present invention; thus they should be included in the protection scope of the present invention and is incorporated here as a reference. Here, LED (light-emitting diode) is a solid semiconductor device that can convert electrical energy into visible light. It may directly convert the electricity into light and takes the light as a control signal.

Preferably, the light-emitting mode for the LED to send the control signal comprises at least an arbitray one of the following items:
shape;
wavelength;
flicker frequency;
brightness;
brightness distribution.

For example, the LED(s) emits light in a certain shape, for example, emitting a triangular, round, or square and other shapes of light; for example, if the LED (s) is manufactured into a special shape, then the emitted light has the particular shape as a control signal; or a plurality of LEDs form a triangular, round or square or other shape, and meanwhile emit light as a control signal; or, each LED in the LED matrix forms a particular shape of lighting pattern as a control signal through light on or off. For another example, the LED(s) emits light with a certain wavelength to form a color corresponding to the wavelength. For another example, the LED(s) emits light with a certain flicker frequency, for example, flickering ten times every second. Or, the (other) LED emits light with certain brightness. Here, the brightness indicates the luminous flux of the (or other) LED per unit solid angle per unit area in a particular direction; the brightness may be expressed by calculating the average value or total sum of the gray value of the corresponding imaging information in the LED frame. Or, the LED(s) emits light with a certain brightness distribution, for example, emitting light with a brightness distribution where the periphery is bright and the center is dark.

More preferably, regardless of the shape, wavelength (color), brightness, or brightness distribution, the LED(s) sends the control signal with a certain flicker frequency, for example, flickering ten times every second; the flicker frequency may also vary for example with a loaded modulation signal (for example, instruction signal).

Those skilled in the art should understand that the above light-emitting mode is only exemplary, and other existing or likely evolved light-emitting mode in the future, for example, may be applicable to the present invention and should also be comprised within the protection scope of the present invention, which is incorporated here as a reference.

Preferably, the light-emitting source sends the control signal in an alternative light emitting-mode, wherein the alternative light-emitting mode comprises at least one of the following:
a light-emitting mode with bright-dark alternative variation;
a light-emitting mode with wavelength alternative variation;
a light-emitting mode with light-spot geometrical feature variation. .

wherein, the light emitting mode of the bright-dark alternative variation includes, but not limited to:

1) With the brightness or darkness of the light-emitting source for a predetermined duration as a signal value, the minimum duration of the brightness or darkness at least is no lower than the exposure time of the camera unit; preferably, the minimum duration time of the brightness or darkness is no lower than the sum of the exposure time of the camera unit and the interval between two exposure times.

For example, with the brightness or darkness of the light-emitting source in a predetermined duration as the signal value, for example, a continuous lighting for 10 ms as 1 value, while the continuous darkness for 10 ms as 0 value, then the signal value for 20 ms continuous lighting and 10 ms continuous darkness is 110. Herein, the minimum duration of the brightness or darkness is no lower than the sum of the exposure time of the camera unit and the interval between two exposure times.

2) With the interval between two bright-dark alternation times of the light-emitting source as the signal value, the minimum interval between the two bright-dark alternations is at least twice of the exposure time of the camera unit, and preferably, the minimum interval between the two bright-dark alternations is at least twice of the sum of the exposure time of the camera unit and the interval between two exposure times.

For example, with the interval between two bright-dark alternation times of the light-emitting source, i.e., the flickering interval, as the signal, if the interval between two flickers is 10 ms, then the signal value is 1; if the interval between two flickers is 20 ms, then the signal value is 2; when the interval between the first flicker and the second flicker is 10 ms, and the interval between the second flicker and the third flicker is 20 ms, the generated signal value is 12. Here, the minimum interval between two bright-dark alternations, i.e., the interval between flickers, should be at least twice of the exposure time of the camera unit. Preferably, the minimum interval between two bright-dark alternations is at least twice of the sum of the exposure time of the camera unit and the interval between two exposure times.

3) With the bright-dark alternative frequency of the light-emitting source as a signal value, the exposure frequency of the camera unit is at least twice of the bright-dark alternation frequency, wherein the exposure frequency is exposure times of the camera unit within a unit time.

For example, with the bright-dark alternative frequency of the light emitting source, i.e., the flickering frequency, as the signal value, for example, if the flicker occurs once within 1 s, the signal value is 1, and twice flickers, the signal value is 2; then when flicker occurs once in the first second and twice in the second second, the generated signal value is 12. Here, the exposure frequency of the camera unit is at least twice of the bright-dark alternation frequency.

Here, the signal value as obtained through the above manner may be used to load a control signal so as to perform a control operation to a controlled device. For example, the signal value 10 may be used to implement the “determine” function, the signal value 110 may be used to perform the “return” function, the signal value 112 may be used to perform a connection request, and the signal value 113 may be used to perform a data transmission request, etc.

For another example, the signal value as obtained through the above manner may be used to determine device IDs so as to distinguish a plurality of to-be-connected devices. For example, a series of signal values after the signal value 20 may be used as a device ID to identify the unique identity of the device, and the series of signal values after the signal value 21 may be used as the rights level of the device, such that identity matching may be performed to the device through the obtained signal value so as to obtain the corresponding rights. For example, the emission identifying means as mentioned hereinafter may distinguish the plurality of emitting means based on the signal values as sent by the plurality of emitting means corresponding to the plurality of to-be-connected devices, and then distinguish the plurality of to-be-connected devices.

For another example, the signal value as obtained in the above manner may be used as a particular mode to perform noise resistance. The particular signal value represents a particular light-emitting rule, while the noise in the natural world generally has no such light-emitting rule. For example, the signal value 12111211 represents that the light source performs bright-dark flickering with a certain brightness time or represents that the light source flickers at a certain bright-dark time interval;, or flicker at a certain flickering frequency. If a detected light spot has no such flicker characteristics, it may be deemed as noise to be deleted.

Preferably, the light emitting mode of light spot geometric feature variation includes, but not limited to, the light emitting source sends the control signal based on the number of light spots, which have been varied, of the light-emitting source, the geometric shape of the variation, etc., or the combination of the above two.

Preferably, the light emitting source sends the control signal in combination with the any of the above plurality of alternative light-emitting modes, for example, sending the control signal with the light emitting mode of the bright-dark alternative variation in combined with the wavelength alternative variation. With LED as an example, the LED emits light in a light emitting mode of red-green alternation plus bright-dark alternation.

More preferably, the alternative light-emitting mode of the light-emitting source further comprises combined light emission of a plurality of light-emitting sources of different wavelengths (colors), and their alternation may be embodied as alternating with combination of different colors. For example, for an emitting means having a plurality of light-emitting sources, each light-emitting source has a certain wavelength (color). The plurality of light-emitting sources flicker at a certain frequency, thereby realizing a light emitting mode with alternation of different wavelengths (colors) of the emitting means; or, for a plurality of emitting means, each emitting means has at least one light-emitting source that has a certain wavelength (color) and flickers at a certain frequency, thereby realizing a light emitting mode in which different wavelengths (colors) of the plurality of emitting devices alternate. Here, a combination of different wavelengths (colors) may form a light-emitting unit through a dual-color LED or more than two LEDs having different wavelengths (colors). More preferably, the light-emitting source may send a control signal using a light emitting mode in which a plurality of different wavelengths (colors) alternate in conjunction with bright-dark alternative variation and light-spot geometrical feature variation. For example, different light-emitting color distributions may be formed by merely lighting one LED thereof at any time or lighting two LEDs simultaneously; or one LED lights constantly, while the other flickers at a certain frequency, thereby achieving alternative light-emitting modes of different color combinations.

Preferably, noise-resistance is realized by adopting a light emitting mode in which one LED lights constantly while the other flickers at a certain frequency. For example, this light emitting mode first uses two LED light-emitting spots to screen off a noise spot of an individual light-emitting spot in the natural world; this light-emitting mode then uses an LED light-emitting spot with a particular color distribution to screen off those noise spots that are not of the particular color in the natural world; further, the light-emitting mode screens off other noise spots which are not in the light-emitting mode by one LED constantly lighting and the other LED flickering at a certain frequency.

Those skilled in the art should understand that the above alternative light-emitting modes are merely exemplary; and other existing or future developed alternative light-emitting modes, if applicable to the present invention, should also be included within the protection scope of the present invention, which are incorporated here as a reference.

The detecting means 12 comprises a camera unit 121 that acquires imaging information of the control signal in the camera unit 121. Here, the detecting means 12 may only comprise a camera unit, for example, a camera sensor that may detect a visible light and an infrared light simultaneously, and it may also comprise a plurality of camera units. The camera unit 121 may sense and collect the visible light and/or infrared image emitted by the LED. Specifically, the camera unit 121 shoots one or more LEDs at the emitting means 11 end at a sufficiently high frame collection rate, for example 15 fps or above, an appropriate resolution, for example, 640×480 or above, and a sufficiently short exposure time, for example, 1/500 or shorter, so as to acquire the imaging information in the camera unit 121 of the control signal sent by the one or more LEDs. For example, each LED in the LED matrix of the emitting means 11, through light on or light off, form a triangular light-emitting pattern, as a control signal; the camera unit 121 shoots the LED matrix to acquire the imaging information in the camera unit 121 of the triangular light-emitting pattern. Here, the imaging information includes, but not limited to, the location information, size of the formed image, shape, and other information of the LED in the LED frame shot by the camera unit 121.

Those skilled in the art should understand that the above imaging information and the manner of acquiring the imaging information are only exemplary, and other existing or likely evolved imaging information or the manner of acquiring the imaging information in the future, if applicable to the present invention, should also be included within the protection scope of the present invention, which is incorporated here as a reference.

The computing means 13 determines the location information of the emitting means 11 based on the imaging information acquired by the detecting means 12. Specifically, the computing means 13, based on the imaging information acquired by the detecting means 12, for example, the location information, the size and shape of the formed image, etc., of the LED in the LED frame shot by the camera unit 121, determines through certain computation the location information of the emitting means 11, for example, the two-dimensional location information, three-dimensional location information, two-dimensional motion trace, and three-dimensional motion trace of the emitting means 11, etc. For example, the computing means 13, based on variation of the location information of the LED at the end of the emitting means 11 in the LED frame shot by the camera unit 121, maps the variation of the location information into a physical space, and then determines the two-dimensional motion trace of the emitting means 11. For another example, the computing means determines the two-dimensional location information of the emitting means 11 based on the location information of the LED at the emitting means 11 in the LED frame shot by the camera unit 121, and further, computes the distance between the LED and the camera unit 121 based on the area size of the corresponding imaging information of the LED in the LED frame in further combination of the actual area size of the LED light spot, so as to determine the three-dimensional location information of the emitting means 11.

Those skilled in the art should understand that the above approaches of computing location information are merely exemplary, and other existing or likely evolved approach of computing location information in the future, if applicable to the present invention, should also be comprised within the protection scope of the present invention, which is incorporated here as a reference.

The controlling means 14 determines a control instruction corresponding to the location information so as to control a controlled device connected to the system. Specifically, the controlling means 14, based on the location information of the emitting means 11 as determined through computation by the computing means 13, for example, one or more of the two-dimensional location information, three-dimensional location information, two-dimensional motion trace, three-dimensional motion trace of the emitting means 11, or a combination of some particular motions therein, acquires a control instruction corresponding to the location information through matching query in an instruction base, so as to control the controlled device connected to the system.

For example, the computing means 13 determines through computation that the location information of the emitting means 11 is a top-to-down two-dimensional motion trace; the controlling means 14, based on the location information, performs matching query in the instruction base and determines that the control instruction corresponding to the location information is a top-to-down scrolling page; further, the controlling means 14, in a cabled communication manner or wireless communication manner such as WIFI, Bluetooth, infrared, etc., sends the control instruction to one or more controlled devices connected to the system 1, so as to control the one or more controlled devices.

Here, the controlling means 14 may simultaneously control a plurality of controlled devices. For example, the controlling means 14 simultaneously sends a control instruction for scrolling a page from top to down to a set-top-box, a gaming machine, and a PC, where the set-top-box, the gaming machine, and the PC, based on the control instruction, simultaneously perform an operation of scrolling a page from top to down. Preferably, the controlling means 14 may also sends the control instruction to a corresponding controlled device according to the priority order from high to low based on the priorities of the plurality of controlled devices.

Here, the instruction base is preset with a mapping relation between location information and a control instruction, where the mapping relation may be updated based on the settings of the user. Here, the controlled device comprises, but not limited to, one or more of a TV set, a set-top-box, a mobile device, a gaming machine, or a PC.

Those skilled in the art should understand that the above approaches of determining a control instruction are only exemplary, and other existing or likely evolved approaches of determining a control instruction in the future, if applicable to the present invention, should also be included in the protection scope of the present invention, which is incorporated here as a reference. Those skilled in the art should also understand that the above controlled devices are merely exemplary, and other existing or likely evolved controlled devices in the future, if applicable to the present invention, should also be comprised within the protection scope of the present invention, which should be incorporated here as a reference.

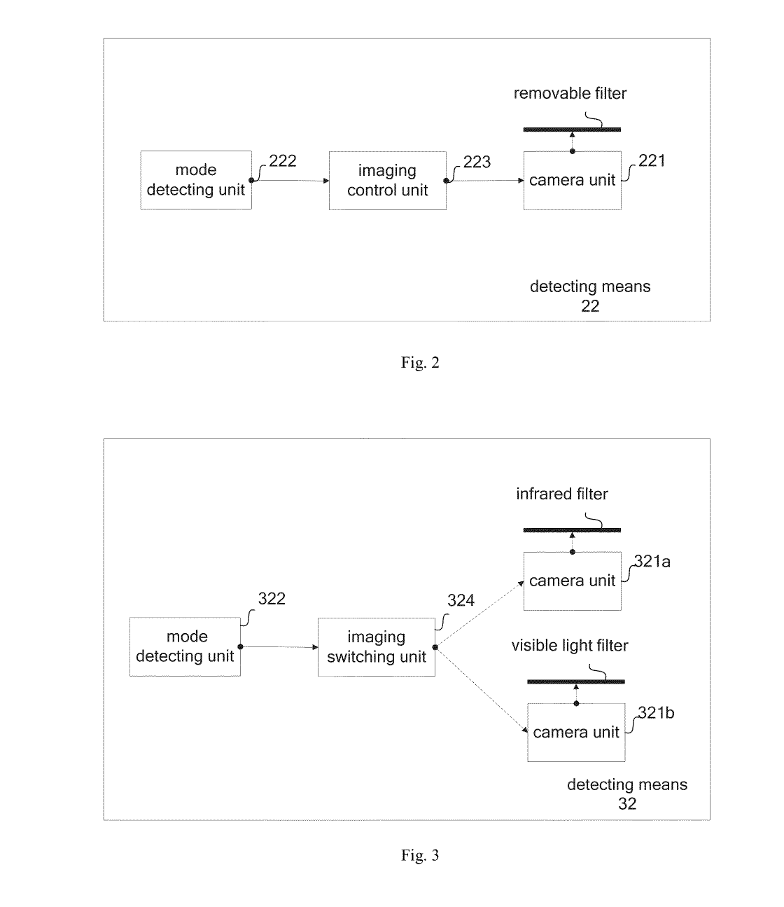

FIG. 2 illustrates an apparatus diagram of a system for remotely controlling a controlled device according to one preferred embodiment of the present invention, wherein the detecting means 22 comprises a camera unit 221, a mode detecting unit 222, and an imaging control unit 223.

In this embodiment, the mode detecting unit 222 detects the working mode of the emitting means 21; a removable filter is attached in front of the camera unit 221; the detecting means 22 further comprises an imaging control unit 223 that performs addition or removal operation to the filter based on the working mode detected by the mode detecting unit 222. Here, the camera unit 221 is a camera sensor that, for example, may detect visible light and infrared light simultaneously; the camera unit 221 is attached with a removable filter in its front, which removable filter comprises an infrared filter and/or visible light filter; the detecting means 22 further comprises an imaging control unit 223, which imaging control unit 223, for example, comprise an electromagnetic switch to control whether to place the infrared filter or visible light filter on the camera unit 221. Suppose the mode detecting unit 22 detects that the emitting means 21 is working in the visible light mode, while the camera already has an infrared filter thereon, then the imaging control unit 223 uses the electromagnetic switch to remove it; otherwise, nothing will be done. Suppose the mode detecting unit 222 detects that the emitting means 21 is working in the infrared mode, while the camera unit 221 has been added thereon with an infrared filter, then nothing will be done; otherwise, the imaging control unit 223 will add the infrared filter on the camera unit 221 with the electromagnetic switch.

Preferably, the mode detecting unit 222 comprises an infrared detection sensor that detects whether the emitting means 21 is working in the infrared mode. For example, the infrared detection sensor detects a control signal sent by the emitting means 21; when it is detected that the control signal is an infrared signal, the infrared detection sensor determines that the emitting means 21 is working in the infrared mode.

More preferably, the mode detecting unit 222 comprises an environment brightness sensor that detects the environment brightness of the environment where the emitting means 21 is located, so as to determine a working mode of the emitting means by comparing the environment brightness with a predetermined brightness threshold. For example, the environment brightness sensor first detects the environment brightness of the environment where the emitting means 21 is located and then further compares the environment brightness with the predetermined brightness threshold, such that when the environment brightness is higher than the brightness threshold, the environment brightness sensor determines that the emitting means 21 is working in the visible light mode or is working in a mode accommodating the visible light and the infrared light; when the environment brightness is lower than the brightness threshold, then the environment brightness sensor determines that the emitting means 21 is working in the infrared mode.

Here, the mode detecting means 222 may merely comprise one of the infrared detection sensor or environment brightness sensor, and may also comprise the two sensors. For example, when the mode detecting unit 222 merely comprises the infrared detection sensor, the system 1 works in a remote control mode; while when the infrared detection sensor detects that the control signal sent by the emitting means 21 is an infrared signal, then it is determined that the emitting means 21 is working in the infrared mode; and when the infrared detection sensor fails to detect an infrared signal sent from the emitting means 21, then it is determined that the emitting means 21 is working in the visible light mode.

FIG. 3 illustrates an apparatus diagram of a system for remotely controlling a controlled device according to one preferred embodiment of the present invention; wherein, the detecting means 32 comprises a camera unit 321a, a camera unit 321b, a mode detecting unit 322, and an imaging switching unit 324.

In this embodiment, the mode detecting unit 322 detects a working mode of the emitting means 31; the detecting unit 22 comprises a camera unit 321a in front of which an infrared filter being disposed and a camera unit 321b in front of which a visible light filter being disposed, and an imaging switching unit 324 that provides to the computing means, based on the working mode determined by the mode detecting unit 322, imaging information of a camera unit in front of which a filter corresponding to the working mode being disposed. Here, the detecting means 22 comprises two camera units, with one of them having an infrared filter being disposed in front to detect the infrared light; the other having a visible light filter being disposed in front to detect the visible light; the imaging switching unit 324 comprises a control circuit that decides whether to suspend a camera unit or decides to start a camera unit; when the mode detecting unit 322 detects the working mode of the emitting means 31, the imaging switching unit 324 selects, through the control circuit, to start the camera unit in front of which a filter corresponding to the working mode being disposed and provides the imaging information of the camera unit to the computing means. For example, when the mode detecting unit 322 detects that the working mode of the emitting means 31 is the infrared mode, the imaging switching unit 324 decides to suspend using the camera unit 321b that has a visible light filter being disposed in front, but using the camera unit 321a that has an infrared light filter being disposed in front; further, the imaging switching unit 324 provides the imaging information of the camera unit 321a that has an infrared light filter being disposed in front to the computing means.

Here, the mode detecting unit 322 performs the same or substantially the same operation as the operation performed by the mode detecting unit 222 in the embodiment of FIG. 2, thus it will not be detailed here but incorporated here as a reference.

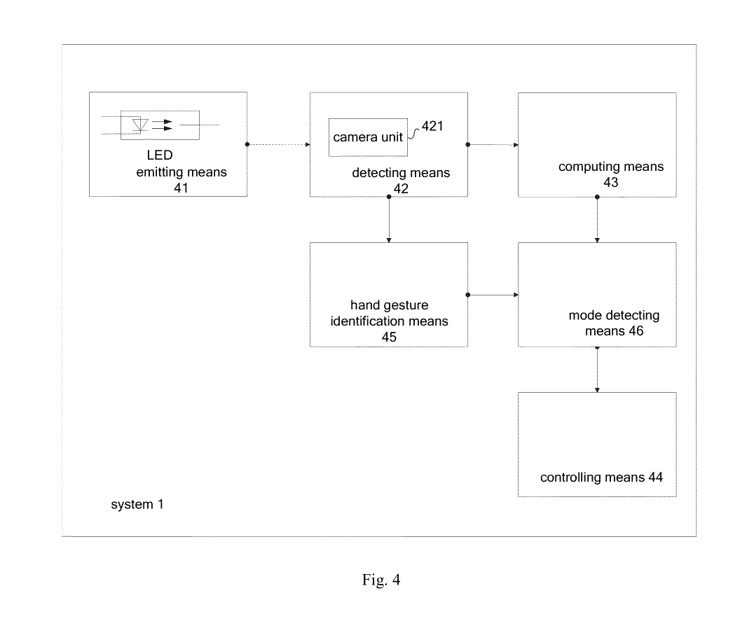

FIG. 4 illustrates a system diagram of a system for remotely controlling a controlled device according a further embodiment of the present invention; the system 1 comprises an emitting means 41, a detecting means 42 comprising a camera unit 421, a computing means 43, a controlling means 44, a hand gesture identification means 45, and a mode identification means 46. Here, the emitting means 41, the detecting means 42, and the computing 43 are identical or similar to the corresponding means as illustrated in FIG. 1, which are thus not detailed here but incorporated here as a reference.

Here, the hand gesture identification means 45 identifies hand gesture imaging information of the user acquired by the camera information 421; the controlling means 44 determines a control instruction corresponding to the location information and the hand gesture imaging information, so as to control the controlled device connected to the system. For example, when the system 1 is working in a remotely control mode in accommodation with the hand gesture mode, the camera unit 421 obtains the imaging information of the control signal and meanwhile obtains the user's hand gesture imaging information; the hand gesture identification means 45, based on the hand gesture imaging information of the user acquired by the camera unit 421, identifies the hand gesture imaging information in a manner such as image processing, for example, identifying the hand gesture imaging information that the user thumbs up; the computing means 43, based on the imaging information of the control signal, determines the location information of the emitting means 41; afterwards, the controlling means 44 determines, based on the location information in combination with the hand gesture imaging information, the control instruction corresponding to the location information and the hand gesture imaging information by performing matching query in the instruction base, so as to control the controlled device connected to the system. Preferably, the controlling means 44 may further determine the corresponding control instruction in combination with the priority level of the location information and the hand gesture imaging information. For example, when the priority of the hand gesture imaging information is higher than those of the location information, the corresponding control instruction may be determined only based on the hand gesture imaging information; or mainly based on the hand gesture imaging information, assisted by the location information of the emitting means 11, the corresponding control instruction is determined.

Preferably, the detecting means 42 further comprises an infrared emission unit (not shown), which infrared emission unit emits infrared light so as to acquire the hand gesture imaging information of the user. Specifically, the infrared emission unit, for example, is an LED that may emit infrared light. Emitting infrared light in the region that may be illuminated by the infrared emission unit enables the user to make a corresponding hand gesture in the region. The camera unit in the detecting means 42 is working in the infrared mode to acquire the hand gesture imaging information of the user.

Preferably, the system further comprises an application mode identification means (not shown), which application mode identification means determines a current application mode of the system based on a predetermined application mode identification rule; afterwards, the controlling means 44 determines the control instruction corresponding to the location information and the hand gesture imaging information based on the current application mode so as to control the controlled device connected to the system. Specifically, the system 1 may comprise different applications, while different applications imply different detection modes. When the user opens an application, the mode identification means, based on the predetermined application mode identification rule, determines the current application mode of the system 1. For example, the system 1 is currently working in the remotely control mode, a hand gesture identification mode, etc. Here, the application mode identification rule comprises, but not limited to, at least one of the following rules:
determining the current application mode based on the working condition of the emitting means;
determining the current application mode based on the priority setting of the application mode;
determining the current application mode based on the current application information of the system.

For example, the application mode identification means detects whether the emitting means 41 is in a working condition through a sensor or the like. When the emitting means 41 is in a working condition, then it is determined that the current application mode of the system 1 is a remotely control mode; otherwise, it is determined that the current application mode of the system 1 is a hand gesture identification mode. For example, suppose it is preset in system 1 that the priority of the hand gesture identification mode is higher than the remotely control mode, then when the system 1 identifies the hand gesture of the user and detects the LED imaging information simultaneously, the application mode identification means determines that the current application mode of the system is the hand gesture identification mode based on the priority setting of the application mode. For another example, the application mode identification means determines a current application mode of the system based on the current application information of the system. If the current application of the system is video call, then the application mode identification means determines that the current application mode of the system is a hand gesture identification mode or an infrared mode in accommodation with visible light mode.

Afterwards, the controlling means 44 determines the control instruction corresponding to the location information and the hand gesture imaging information based on the current application mode of the system as determined by the application mode identification means. If the current application mode of the system 1 is the hand gesture identification mode, then the controlling means 14 determines a corresponding instruction based on the hand gesture imaging information so as to control the controlled device connected to the system; or, if the current application mode of the system 1 is a remotely control mode, then the controlling means 14 determines a corresponding control instruction based on the location information of the emitting means 41.

Those skilled in the art should understand that the above application mode identification rule is only exemplary, and other existing or likely evolved application mode identification rules in the future, if applicable to the present invention, should also be included within the protection scope of the present invention, which are incorporated here as a reference.

In one preferred embodiment (see FIG. 1), the emitting means 11 comprises a plurality of LEDs for sending a control signal, wherein the computing means 13 determines the location information of the emitting means based on the imaging information of a plurality of control signals corresponding to the plurality of LEDs. Specifically, the emitting means 11 comprises a plurality of LEDs for sending a control signal. The plurality of LEDs send the control signals with a certain shape, wavelength, flicker frequency, brightness, or brightness distribution, or other light-emitting mode. For example, the plurality of LEDs form a triangular, round, or square shape, and meanwhile emit light as control signals; or, a plurality of LEDs in an LED matrix form a light-emitting pattern with a particular shape as a control signal through light on or light off. Afterwards, the computing means 13, based on the imaging information of a plurality of control signals corresponding to the plurality of LEDs, for example, the location information of the plurality of LEDs in the LED frame shot by the camera unit 121, the size and shape of the formed image, etc., determines the location information of the emitting means 11 through certain computation, for example, the two-dimensional location information, three-dimensional location information, two-dimensional motion trace, three-dimensional motion trace, etc., of the emitting means 11. For example, the computing means 13 computes the location information of the plurality of LEDs, respectively, and then performs certain conversion computation with respect to the plurality of location information, for example, weighted averaging computation, etc., to determine the location information of the emitting means 11 where the plurality of LEDs are located.

Preferably, the system 1 comprises a plurality of emitting means, each of which plurality of emitting means comprises an light-emitting source for sending a control signal, wherein the system 1 further comprises an emission identifying means (not shown) for identifying the plurality of emitting means. Here, the system may emit visible or infrared light to the receiving means simultaneously from more than one emitting means; the detecting means 12 obtains imaging information of these visible or infrared lights in the camera unit, respectively; the imaging information calculating means 13 calculates the two-dimensional or three-dimensional location information of the plurality of emitting means, respectively. For example, the system may detect candidate imaging information using the above method. If there are N emitting means to the utmost, then the system may detect the remote controller corresponding to the N emitting means, to extract the eligible utmost N candidate imaging information as the imaging information corresponding to those emitting means; and then extract their corresponding imaging feature information to distinguish different emitting means (1, 2, . . . , N). Specifically, the emission identifying means identifiers the plurality of emitting means in the following manners, including but not limited to:

1) Identifying the plurality of emitting means based on the light emitting mode in which the light emitting source of each of the plurality of emitting means sends the control signal. For example, suppose the light-emitting source, for example, LED, on each emitting means, uses different light emitting modes of shape, wavelength (color), flicker frequency, brightness, brightness distribution or a combination thereof, to emit light, then the emission identifying means distinguish different emitting means based on the light emitting mode of those emitting means. Here, the emission identifying means may detect different sizes of round using a common method in image processing based on the imaging information corresponding to the LED of the plurality of emitting means, and identify a triangle or quadrangle and the like through straight-line detection or angular-point detection to the area edge, to thereby distinguish different emitting means. Or, the emission identifying means may distinguish different emitting means based on different flicker frequencies; at this point, the acquisition frame ratio of the camera unit must be larger than twice of the LED highest flicker frequency (preferable, above triple); or the emission identifying means detects the flicker frequency of the LED using the differential method to further distinguish different transmitting terminals; or the emission identifying means uses different colors or a combination thereof to distinguish different emitting terminals; as to color detection, it may use a color camera to capture light spots and then distinguish dominate colors in the light-spot area using RGB or other color spaces; or corresponding to different brightness distribution modes, the emission identifying means may use the intensity distribution of samples of different emitting means (for example, all pixel intensity values within the light spot) to pre-train a classifier (for example, LDA classifier), and when in use, each light spot is ascribed to a classification result of the classifier.

Preferably, the emission identifying means may identify the plurality of emitting means based on the alternative light-emitting modes of the plurality of light emitting means. For example, the emission identifying means identifies the plurality of emitting means based on the signal values obtained when the light emitting sources of the plurality of emitting means send the control signal in a light-emitting mode of bright-dark alternative variation.

2) Identifying the plurality of emitting means based on the motion trace of the imaging information corresponding to the light-emitting source of each of the plurality of emitting means. For example, the emission identifying means may use a video tracking technology to distinguish motion traces of different LEDs so as to distinguish different emitting means at any time, for example, which imaging information belongs to an emitting means started at time i, and while belongs to an emitting means started at time j, i.e., the specific locations for the emitting means started at any time i and the emitting means started at time j, and then perform corresponding operations. Once candidate imaging information is detected per frame, the each imaging information may be tracked based on a motion model (for example, a model of a constant speed or acceleration speed) using the existing method for target tracking. For example, suppose there are N emitting means to the utmost, then the emission identifying means extracts the motion traces of N eligible imaging information as the candidate imaging information; afterwards, the emission identifying means records historical features such as the start time and location of each motion trace till the track ends; each motion trace at any time corresponds to an emitting means.

Further, after the emission identifying means identifies different emitting means, the computing means 13 computes location information of the different emitting means, and the controlling means 14 determines different control instructions corresponding to different location information so as to send the different control instructions to corresponding controlled devices.

Preferably, the emission identifying means may also determine priorities corresponding to different emitting means. For example, the emission identifying means distinguishes different emitting means corresponding to different LEDs based on the start time and location or the motion area of the track (front or back, left or right) of the imaging information corresponding to the LED. For example, the emitting means that starts the earliest (which may be determined based on the time when the imaging information is detected) is always a master control and has a higher priority; or the emitting means whose corresponding location information is in the front or middle region is always a master control and has a higher priority.

In another preferred embodiment (with reference to FIG. 1), the system 1 further comprises an auxiliary information acquiring means (not shown) that acquires auxiliary information corresponding to the imaging information based on the imaging information of the control signal in the camera unit 121, wherein the controlling means 14 determines the control instruction corresponding to the location information and the auxiliary information so as to control the controlled device corresponding to the remotely control system. Specifically, the auxiliary information acquiring means obtains, based on the imaging information of the control signal corresponding to the LEDs in the camera unit 121, the auxiliary information corresponding to the imaging information, where the auxiliary information includes, but not limited to, the color, brightness, the formed pattern, etc., of the imaging information; afterwards, the controlling means 14, based on the location information of the LEDs determined by the computing means 13 as well as one or more of the auxiliary information, performs matching query in the instruction base to determine the corresponding control instruction, so as to control the controlled device corresponding to the remotely control system. For example, each LED in the LED matrix of the emitting means 11 forms a triangular light-emitting pattern through light on or off, as a control signal; the camera unit 121 obtains the imaging information of the triangular light-emitting pattern in the camera unit 121 by shooting the LED matrix; the computing means 13, based on the imaging information, computes the location information of the emitting means 11; the auxiliary information acquiring means, based on the imaging information, obtains the auxiliary information that the LED forms a triangular pattern; the controlling means 14, based on the triangular pattern and the location information, determines that the corresponding control instruction to be suspending the play, so as to control the corresponding controlled device, thereby suspend the play of the controlled device.

In a still further preferred embodiment (see FIG. 1), the detecting means 12 comprises a plurality of camera units for acquiring the imaging information of the control signal, respectively, wherein the computing means 13 determines the location information of the emitting means 11 based on the plurality of imaging information acquired by the plurality of camera units. Here, the plurality of camera units, for example, working on the same working mode, shoots one or more LEDs at the emitting means 11 end at a same rate of collecting frames, a same resolution, and a same exposure time, etc., to acquire the imaging information of the controlled signals sent by the one or more LEDs in the plurality of camera units 121, respectively. The computing means 13, based on the plurality of imaging information acquired by the plurality of camera units, for example, the location information, the size and shape of the formed image, etc., of the one or more LEDs in the LED frame shot by the plurality of camera units, respectively, determines the location information of the emitting means 11 through certain computation, for example, the two-dimensional location information, three-dimensional location information, two-dimensional motion trace, three-dimensional motion trace, etc., of the emitting means 11. For example, the detecting means 12 comprises two camera units that obtain the imaging information of the control signals sent by the emitting means 11, respectively; the computing means 13 computes the location information of the emitting means 11 utilizing the binocular stereo vision algorithm.

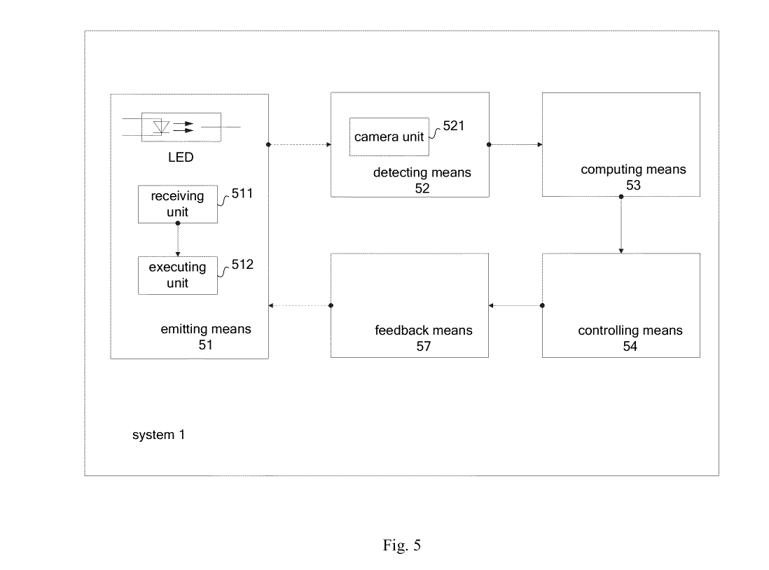

FIG. 5 illustrates a system diagram of a system for remotely controlling a controlled device according to a still further embodiment of the present invention. The system 1 comprises an emitting means 51, a detecting means 52, a computing means 53, a controlling means 54, and a feedback means 57, wherein the emitting means 51 comprises a receiving unit 511 and an execution unit 512. Here, the detecting means 52, the computing means 53, and the controlling means 54 are identical or similar to the corresponding means in FIG. 1, respectively, which will not be detailed here and incorporated here as a reference.

Here, the feedback means 57 sends feedback information corresponding to the control signal to the emitting means 51; the emitting means 51 further comprises a receiving unit 511 and an execution unit 512, where the receiving unit 511 receives the feedback information and the execution unit 512 executes an operation corresponding to the feedback information based on the feedback information. Here, the feedback information sent by the feedback means 57 to the emitting means 51 includes, but not limited to: 1) receipt statement to indicate that the detecting means 52 has detected the location information of the emitting means 51; 2) feedback instruction to enable the emitting means 51 to execute a corresponding operation based on the feedback instruction, for example, having the emitting means 51 execute a vibration like a gaming handle so as to increase the trueness of the game, issue a particular corresponding voice, emit light of a particular color frequency, etc. Here, the wireless communication manner between the emitting means 51 and the feedback means 57 includes, but not limited to, a wired communication manner, or a wireless communication manner such as WIFI, Bluetooth, infrared, etc.

Preferably, the executing unit 512 adjusts the brightness control information of the light emitting source based on the distance information and/or brightness information of the imaging information included in the feedback information. For example, the feedback information as sent by the feedback means 57 to the emitting means 51 comprises the distance information and/or brightness information of the imaging information. If the current working distance between the emitting means 51 and the detecting means 52 is relatively short and/or the brightness of the imaging information corresponding to the light emitting source of the emitting means 51 is relatively high, then the executing unit 512 adjusts the brightness control information of the light-emitting source based on the feedback information such that the light emitting source of the emitting means works in a low brightness manner; when the feedback information shows that the current working distance between the emitting means 51 and the detecting means 52 is relatively far and/or the brightness of the imaging information corresponding to the light emitting source of the emitting means 51 is relatively low, then the executing unit 512 adjusts the brightness control information of the light emitting source based on the feedback information such that the light emitting source of the emitting means works in a high brightness manner.

Here, when the working distance is short or the brightness of the imaging information is high, the emitting means works in a low brightness manner, which therefore saves power; in turn, when the working distance is far or the brightness of the imaging information is low, the emitting means works in a high brightness manner, which thereby broadens the operation range.

Here, the system sends feedback information from the feedback means to the emitting means using communication manners such as WIFI, Bluetooth, or infrared, so as to help the system to work in a best mode and achieve a higher precision, a better experience, a lower power consumption, better noise resistance, or a greater operation range, etc.

More preferably, since the input environment and relevant information (for example, the current working distance) of the imaging information may be detected at the detecting means, the detecting means may send feedback information to the emitting means to indicate the working mode of the emitting meas. For example, when the detecting means 52 detects that the brightness of the obtained imaging frame is relatively low, when the system is working in a low-brightness environment, the feedback means 57 may indicate the emitting means to work in a low power consumption manner. If the environmental noise is high and there is a plurality of candidate imaging information, the feedback means 57 may indicate the light emitting source of the emitting means, for example, LED and the like, to flicker at a certain frequency, and the system can detect the bright-dark variation of the light spot to thereby effectively distinguish background noise and imaging information. The feedback means 57 may also send an indication to the emitting means based on the specific application or use mode such that the emitting means works in different manners. For example, when the system is required to work in an infrared state, the feedback means 57 sends an indication to the emitting means 51 to indicate that the emitting means 51 uses an infrared LED; otherwise, it uses a visible light LED. For another example, when the system is required to use the camera for other purpose (for example, video call), the feedback means 57 sends an indication to the emitting means 51 to indicate the emitting means 51 to work in a particular mode, for example, the LED at the emitting means end emits light at a certain flickering and high brightness manner. For a further example, when the emitting means 51 has a plurality of LEDs, the system may start different LEDs or the combinations thereof based on a specific application, and the feedback means 57 sends an indication to the emitting means 51 to indicate that the emitting means 51 starts different LEDs or a combination thereof.

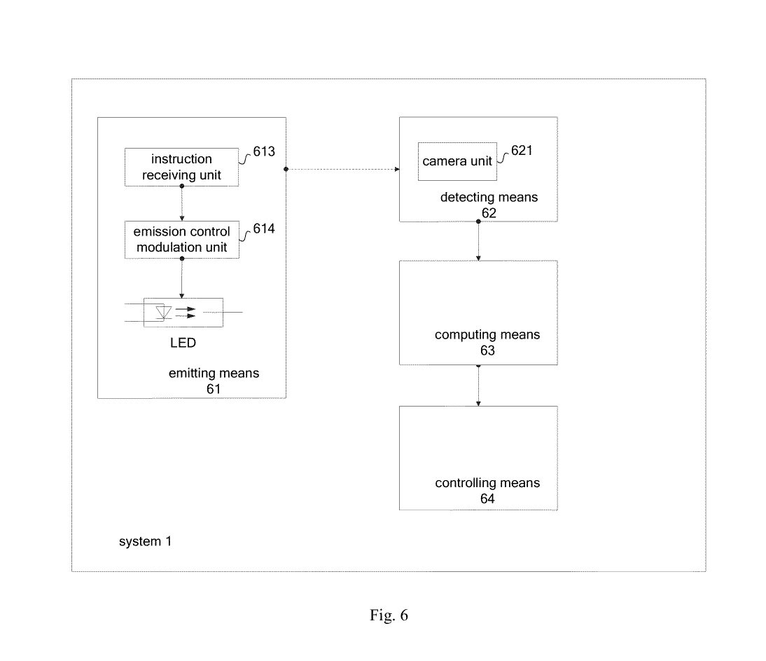

FIG. 6 illustrates a system diagram of a system for remotely controlling a controlled device according to a yet further embodiment of the present invention. The system 1 comprises an emitting means 61, a detecting means 62 comprising a camera unit 621, a computing means 63, and a controlling means 64, wherein the emitting means 61 comprises an instruction acquiring unit 613 and an emission control modulation unit 614. Here, the computing means 63 and the controlling means 64 are identical or similar to the corresponding means in FIG. 1, which are thus not detailed here, but incorporated here as a reference.

In this embodiment, the instruction acquiring unit 613 in the emitting means 61 obtains instruction information to be sent by the user through the emitting means; the emission control modulation unit 614 controls the LED to send the control signal at a certain flicker frequency based on the instruction information, wherein the brightness variation of the control signal corresponds to the instruction information; wherein the camera unit 621 in the detecting means 62 obtains the imaging information and the brightness variation at an exposure frequency at least twice of the flicker frequency; wherein the controlling means 64, based on the location information and the brightness variation, determines the control instruction so as to control the controlled device corresponding to the remote control system.

Specifically, the user inputs the instruction information to be sent by the user through interaction with the emitting means 61. For example, if the emitting means 61 is a remote controller, the user inputs the instruction information to be sent, for example, key information, by pressing a key on the remote controller, and then the instruction acquiring unit 613 obtains the instruction information to be sent by the user through the emitting means 61. The emission control modulation unit 614 controls the LED in the emitting means 61 based on the instruction information, such that the LEDs send the control signal at a certain flicker frequency, for example, enabling the LED(s) load the instruction information at a high-frequency flickering to send the control signal. Here, the brightness variation of the control signal corresponds to the instruction information. For example, the user intends to send instruction information of suspending play by pressing a key on the emitting means 61, while the brightness variation of the control signal corresponding to the instruction information is bright, dark, bright, dark, bright; the instruction acquiring unit 613 obtains the instruction information; the emission control modulation unit 614 control the LED in the emitting means 61 based on the instruction information to send the control signal at a flicker frequency of flickering 5 times every second; then the LED sends the control signal at the flicker frequency with a brightness variation of “bright, dark, bright, dark, bright.” Meanwhile, the camera unit 621 obtains the imaging information of the emitting means 61 and the brightness variation of the control signal at an exposure frequency at least twice of the flicker frequency; the controlling means 64, based on the location information of the emitting means 61 and the brightness variation of the control signal, determines a corresponding control instruction by performing matching query in the instruction base, so as to control the controlled device corresponding to the remote control system. Continuing the above example, it is determined that the corresponding control instruction is suspending play, for controlling the corresponding controlled device to suspend play.

Here, when the exposure frequency of the camera unit is at least twice of the flicker frequency of the LED, preferably more than triple, the bright and dark variation of the LED light spot for each time will be captured, and then the flicker frequency may be computed through the bright times of the light spot during a certain period of time; further, the instruction information as loaded through LED may be acquired by detecting and decoding the LED flicker frequency, such that the system 1 simultaneously detects the location information of the emitting means and transmits the instruction information.

In another preferred embodiment (referring to FIG. 1), the emitting means 11 further comprises an instruction acquiring unit (not shown) and an instruction sending unit (not shown), and the system further comprises an instruction receiving means (not shown). Specifically, the user inputs the instruction information that is intended to be sent by the user through interaction with the emitting means 11. For example, if the emitting means 11 is a remote controller, the user inputs the instruction information to be sent, for example, key information, by pressing a key on the remote controller; the instruction acquiring unit acquires the instruction information intended to be sent by the user through the emitting means 11; afterwards, the instruction sending unit performs operations such as encoding, modulating, on the instruction information, so as to generate a corresponding instruction signal, and sends the instruction signal out through wired communication manner, or through wireless communication manner such as WIFI, Bluetooth, infrared, etc. The instruction receiving means receives an instruction signal from the emitting means through the above wired or wireless communication manner; afterwards, the controlling means 14 performs operations such as scaling up, shaping, demodulation, and decoding, on the instruction signal, and then in further combination of the location information of the emitting means 11 as computed by the computing means 13, determines the control instruction corresponding to the location information and the instruction signal, so as to control the controlled device connected to the system. Here, the encoding manner of the instruction sending unit with respect to the instruction information may adopt the encoding manner of the current infrared remote controller, so as to generate an instruction signal; the instruction receiving means, for example, receives the loaded instruction signal at the 38KHz carrier in an infrared receiving manner.

Here, the instruction sending unit comprises, but not limited to, an infrared emitting means, a visible light emitting means, a radio emitting means (including, but not limited to Bluetooth, WIFI, NFC), a radio frequency emitting means or an acoustic wave emitting means, etc.

In a still further preferred embodiment (referring to FIG. 1), the emitting means 11 further comprises a switch unit (not shown) for performing switch control and/or brightness tuning to the LED, where the switch unit performs the switch operation and/or brightness tuning on the emitting means 11 based on an operation of the user. Specifically, the emitting means 11 comprises a switch unit for performing switch control and/or brightness tuning on the LED, wherein the switch unit comprises a touch key switching unit to perform corresponding operations on the emitting means based on the pressing, or raising, or touching operation of the user. The switch unit is for example, a pressable touch key, such that the emitting means 11 implements clicking (selection) and dragging functions. When the user touches the touch key, the emitting means 11 starts the LED or has the LED send a control signal in a continuous particular mode, for example, sending an infrared light, to enable the detecting means 12 to detect the imaging information of the emitting means 11 and enables the computing means 13 to compute the location information of the emitting means 11. When the user presses this touch key, it corresponds to the click (selection) function; when the user presses the touch key but does not release it, it corresponds to the dragging function. Or, the switch unit may be a dedicated manual button in stead of touch start, so as to open the LED or have the LED send the control signal in a continuous particular mode.

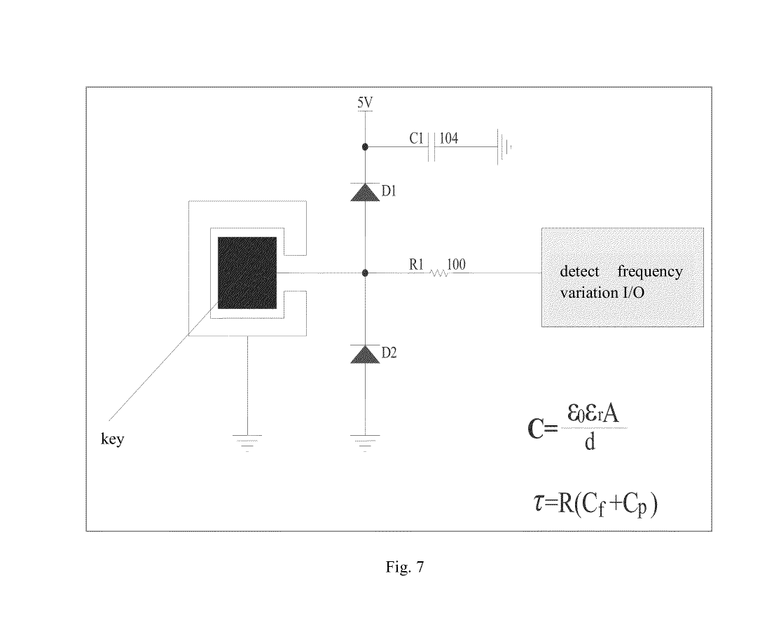

FIG. 7 illustrates a diagram of a touch key circuit according to a yet further embodiment of the present invention.

First, a parasitic capacitance Cₚ is formed between the welding pad and the ground, such that when the finger touches the welding pad, a capacitance C_{f} is formed between the touch point-finger-ground, and the two capacitances are connected in parallel. The parallel capacitances add, thus when the finger touches the welding pad, the total capacitance increases. The percentage of the capacitance increment is:

$$Δ C = \frac{( ( Cp + Cf ) - Cp )}{Cp} = \frac{Cf}{Cp} ,$$

while the increment of the capacitance is just the basis to detect. Because extra capacitance will be generated when the finger touches the key, τ=R(Cf+Cp), the time constant of the oscillator will change, and with the increase of the time constant, the oscillator frequency will decrease. Frequency change may be detected through a single-chip machine, thereby determining whether a key press exists. Second, two diodes are added at the input end of the circuit, so as to protect the I/O port of the single-chip machine. When the voltage exceeds Vdd+0.7V, the diode D1 will be conductive, and the current flows into the capacitance C1; if the voltage is lower than GND-0.7V, the diode D2 will be conductive, and the current flows into the circuit. The resistance R1 is to guarantee first trigger of the external diode, which plays a protection role to the whole circuit.

Preferably, the touch key switching unit performs a corresponding operation on the emitting means based on the user's pressing or raising or touching operation. Traditional keys always perform one function on one key, for example, for right-handed mouse keys, the left key is an enter key, while the right key is the shortcut key. The keys only have two states: press and raise; besides, there is no overlap between the two key states, i.e., the key is either in a raised state or in a pressed state. Here, the keys of the touch button switch unit have three states: touch state, press, or raise. The touch state means a finger touches the key lightly; the pressing and raising states are identical to a traditional mechanical key, and there is no overlap between the two states either. However, the touch state may have an overlap with the pressing or raising states. The following table shows a true value table of all possible states for a key of a touch key switching unit.

TABLE 1
True Table Value of Key States of A Touch Key Switching Unit

| | Touch state | | |
|---|---|---|---|
| | 0 | 1 | 1 |
| Pressing | 0 | 0 | 1 |
| Raising | 1 | 1 | 0 |

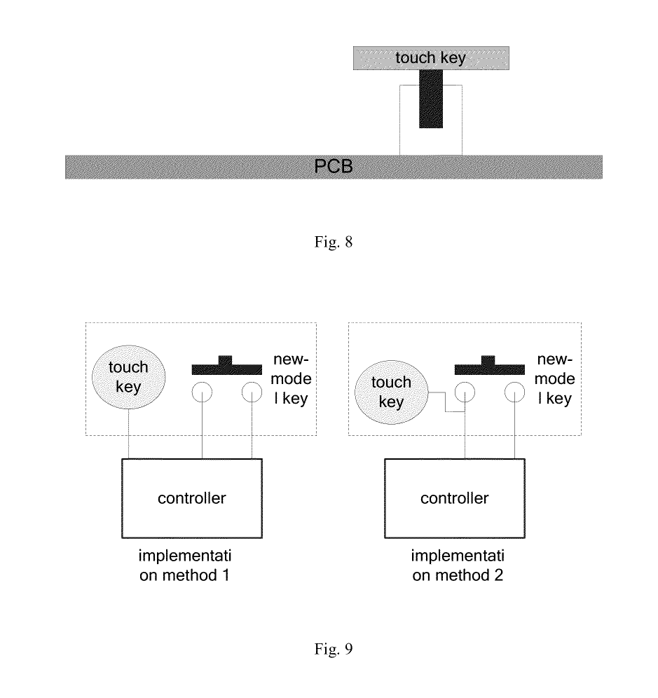

FIG. 8 shows a structural diagram of a touch key switching unit according to a still further embodiment of the present invention.

The touch key switching unit comprises a traditional mechanical key and a touch key. Structurally, a touch key is superposed on the traditional mechanical key, where the mechanical key is disposed at the lower part, and the touch key is superposed above the mechanical key. When a hand does not fall on the touch key, the key is in a raised state; when the hand touches the touch key, the controller detects the touch of the hand, and the touch state and the raise state of the key are valid simultaneously; when the hand presses down the mechanical portion of the key, the touch state and the pressing state are valid simultaneously.

FIG. 9 shows a circuit diagram of a touch key switching unit according to a yet further embodiment of the present invention.

In circuit design, the mechanical key and the touch key of the touch key switching unit are detected separately. When performing detection on the keys of the touch key switching unit, the mechanical key is detected first; if the mechanical key is in a pressing state, then the touch key must be in a pressing state, and it would be unnecessary to further detect the touch key; if the mechanical key is in a raised state, then it is necessary to detect the state of the touch key.

Preferably (see FIG. 1), the system further comprises a state switching trigger means (not shown). The state switching triggering means detects whether a sleep trigger condition for switching the system to the sleep mode is satisfied; wherein when the sleep trigger condition is satisfied, the detecting means 12 performs a sleep backend operation. Specifically, the state switching triggering means detects whether the sleep trigger condition for switching the system to the sleep mode is satisfied, wherein the sleep triggering condition comprises for example: no mouse input and no light-emitting source being detected during a predetermined time period, etc.; when the sleep trigger condition is satisfied, the detecting means 12 may record, in the sleep mode, information that may affect the system working mode operation, such as background noise location, analysis background (for example, brightness, etc.), human face location detection, motion detection, etc. For example, the recording on the background noise location may help the system to reduce noise, for example, the system may preferably select candidate imaging information at a non-noise location as the input imaging information, etc.

Preferably, when the sleep backend operation comprises adjusting the exposure frequency of the camera unit, the detecting means 12 obtains the imaging information of the control signal in the camera unit based on the adjusted exposure frequency. Specifically, the state switching triggering means detects whether a sleep trigger condition for switching the system into the sleep mode is satisfied, the sleep trigger condition comprising, for example, no mouse input and no light emitting source being detected within the predetermined period time, etc.; when the sleep trigger condition is satisfied, the detection means 12 adjusts the exposure frequency of the camera unit thereon, for example, reducing the exposure frequency of the camera unit; next, based on the adjusted exposure frequency, obtains the imaging information of the control signal in the camera unit based on the adjusted exposure frequency.

Here, the system reduces the exposure frequency of the camera unit in the sleep mode, for example, processing once every several frames, thereby further reducing the computational overheads and power consumption of the processor.

More preferably, the state switching trigger means detects whether a ready trigger condition for switching the system into the ready mode is satisfied, wherein the detecting means 12, when the ready trigger condition is satisfied, enters into a working mode corresponding to the ready trigger condition. Specifically, the state switching trigger means detects whether a ready trigger condition for switching the system into the ready mode is satisfied, the ready trigger condition comprises for example, receiving information from a system application or other particular signal (for example, infrared transmitted code), or receiving information as generated from automatic detection in the sleep mode, for example, detecting mouse input, human face, motion of the background, or abrupt brightness change of the background, or input light spot, etc.; when the ready trigger condition is satisfied, the detecting means 12 enters into a working mode corresponding to the ready trigger condition, for example, when a mouse input, human face, etc., is detected, then the detecting means 12 enters into the visible light working mode; when motion or abrupt brightness change occurs to the background, or an input light spot is detected, then the detecting means 12 enters into the infrared working mode, etc.

In a still further preferred embodiment (referring to FIG. 1), the location information of the emitting means 11 comprises three-dimensional location information, wherein the computing means 13 further comprises a light spot detecting unit (not shown) and a three-dimensional computing unit (not shown). Specifically, the light spot detecting unit detects the input light spot corresponding to the emitting means 11 based on the imaging information acquired by the detecting means; the three-dimensional computing unit computes the three-dimensional location information of the emitting means 11 based on the light spot attribute information of the input light spot. Here, the light spot attribute information of the input light spot includes, but not limited to, any relevant optical attributes that are applicable to the present invention and may be directly or indirectly used to determine the three-dimensional location information of the emitting means 11, such as the radius, brightness, or optical distribution feature of the input light spot, etc. The three-dimensional location information of the emitting means 11 comprises three-dimensional translational location information of the emitting means 11 and/or three-dimensional rotational location information of the emitting means 11. Here, the three-dimensional coordinate of a spatial origin is marked as (x₀, y₀, z₀), then the three-dimensional translational location information of the emitting means 11 is its three-dimensional coordinate (x, y, z), where x denotes the horizontal coordinate of the center of mass of the emitting means 11, y denotes the vertical coordinate of the center of mass of the emitting means 11, and z denotes the depth coordinate of the center of mass of the emitting means 11. Further, the three-dimensional rotational location information of the emitting means 11, for example, is the angle θ between the axis of the emitting means 11 and the connection line from the emitting means 11 to the camera unit 121; further, the three-dimensional rotational location information of the emitting means 11 may also be expressed for example as the rotating angle of the emitting means 11 about its mass axis, i.e., the self-rotating angle of the emitting means 11. For example, the camera unit 121 shoots the imaging information of the LED of the emitting means 11; afterwards, the light spot detecting unit detects the light spot radius r and brightness I of the light spot corresponding to the imaging information; next, the three-dimensional computing unit obtains the angle θ between the axis of the emitting means 11 and the connection line from the emitting means 11 to the camera unit 121, i.e., the three-dimensional rotational location information of the emitting means 11, according to the radius r and the brightness I and based on a predetermined angle fitting curve θ0=h(r, I).

More preferably, the controlling means 14 determines the control instruction corresponding to the three-dimensional rotational location information so as to control the controlled device connected to the system. Specifically, the controlling means 14, determines the corresponding control instruction based on the three-dimensional rotational location information of the emitting means 11 as acquired by the rotary location acquiring unit, for example, the self-rotating angle of the emitting means 11, or the angel θ between its axis and the connection line from the emitting means 11 to the camera unit 121, or the variation of the angle so as to control the corresponding controlled device without the click operation by the user. For example, when the user tilts up the remote controller (i.e., the emitting means 11), the screen menu of the controlled device automatically scrolls upward, and the scrolling speed is related to the elevation; when the user stops tilting up the remote controller, the screen menu stops scrolling. For another example, when the user moves the remote controller (i.e., the emitting means 11) from left to right at a distance exceeding a threshold, the picture on the screen of the corresponding controlled device turns to the next page; or, when the user draws a circle with the remote controller (i.e., the emitting means 11), then the corresponding controlled device enters into the control menu page, etc. In order to prevent misoperation and jitter, if the corresponding controlled device enters into a state (for example, scrolling the manual), a high threshold must be exceeded, and to stop this condition, it is required to be lower than a low threshold. There is a gap between the high threshold and the low threshold, so as to prevent jittering between the two states.

Preferably, the emitting means 11 further comprises a spacing unit at the periphery of the LED, wherein the part of the spacing unit facing the camera unit is dark or covered with a light absorption material. For example, the spacing unit may be a sphere wrapping the LED, where the sphere comprises a recess such that the LED may emit a control signal through the recess. The part of the sphere facing the camera unit is dark or covered with a light absorption material, such that the LED is always surrounded by a dark area and not connected to the background or other luminous area, so as to facilitate detecting and analyzing the imaging information corresponding to the LED. For another example, the spacing unit may be a plate in a certain shape, whose area is greater than the size of the light spot of the LED; further, the LED is disposed at the middle of the connecting line between the spacing unit and the camera unit; the part of the plate facing the camera unit is dark or covered with a light absorption material.

Here, the shape, structure and size of the spacing unit should not be limited to the above example, and other any spacing unit whose angle scope in use may surround the LED background but does not block the light spot of the LED should be included within the protection scope of the present invention and is incorporated here as a reference.

To those skilled in the art, it is apparent that the present invention is not limited to the details of the above exemplary embodiments, and the present invention may be implemented with other embodiments without departing from the spirit or basic features of the present invention. Thus, in any way, the embodiments should be regarded as exemplary, not limitative; the scope of the present invention is limited by the appended claims, instead of the above depiction. Thus, all variations intended to fall into the meaning and scope of equivalent elements of the claims should be covered within the present invention. No reference signs in the claims should be regarded as limiting the involved claims. Besides, it is apparent that the term “comprise” does not exclude other units or steps, and singularity does not exclude plurality. A plurality of units or means stated in the apparatus claims may also be implemented by a single unit or means through software or hardware. Terms such as the first and the second are used to indicate names, but do not indicate any particular sequence.

1. A system for remotely controlling a controlled device, wherein the system comprises:
emitting means that comprises a light-emitting source for sending a control signal;
detecting means that comprises a camera unit for acquiring imaging information of the control signal in the camera unit;
computing means for determining location information of the emitting means based on the imaging information acquired by the detecting means;
controlling means for determining a control instruction corresponding to the location information so as to control a controlled device connected to the system.

2. The system according to claim 1, wherein the detecting means further comprises a mode detecting unit for detecting a working mode of the emitting means; wherein a removable filter is attached in front of the camera unit; the detecting means further comprises an imaging control unit that performs an addition or removing operation to the filter based on the working mode detected by the mode detecting unit.

3. The system according to claim 2, wherein the mode detecting unit comprises an infrared detection sensor for detecting whether the emitting means is working in an infrared mode.

4. The system according to claim 2, wherein the mode detecting unit comprises an environment brightness sensor for detecting an environment brightness of the environment where the emitting means is located, so as to determine a working mode of the emitting means by comparing the environment brightness with a predetermined brightness threshold.

5. The system according to claim 1, wherein the detecting means further comprises a mode detecting unit for detecting a working mode of the emitting means; wherein the detecting means comprises two camera units in front of which an infrared filter and a visible light filter being disposed respectively, and an imaging switching unit for providing, according to the working mode, imaging information of a camera unit, in front of which a filter corresponding to the working mode being disposed to the computing means.

6. The system according to claim 1, wherein the system further comprises a hand gesture identifying means for identifying a hand gesture imaging information of the user as acquired by the camera unit; wherein the controlling means is for determining a control instruction corresponding to the location information and the hand gesture imaging information, so as to control the controlled device connected to the system.

7. The system according to claim 6, wherein the detecting means further comprises an infrared emission unit for emitting an infrared light, so as to acquire hand gesture imaging information of the user.

8. The system according to claim 6, wherein the system further comprises an application mode identifying means for determining a current application mode of the system based on a predetermined application mode identifying rule; wherein the controlling means is for determining the control instruction corresponding to the location information and the hand gesture imaging information based on the current application mode, so as to control the controlled device connected to the system.

9. The system according to claim 8, wherein the application mode identifying rule comprises at least one of the following rules:
determining the current application mode based on a working state of the emitting means;
determining the current application mode based on a priority setting of application modes; and
determining the current application mode based on current application information of the system.

10. The system according to any one of claim 1. wherein the emitting means comprises a plurality of light-emitting sources for sending control signals; wherein, the computing means is for determining location information of the emitting means based on imaging information of a plurality of control signals corresponding to the plurality of light-emitting sources.

11. The system according to claim 1 , wherein the system comprises a plurality of emitting means each of which comprises a light-emitting source for sending a control signal, wherein the system further comprises an emission identifying means for identifying the plurality of emitting means.

12. The system according to claim 11, wherein the emission identifying means is for:
identifying the plurality of emitting means based on a light emitting mode in which a light emitting source of each of the plurality of emitting means sends the control signal.

13. The system according to claim 11, wherein the emission identifying means is for:
identifying the plurality of emitting means based on a motion trace of imaging information corresponding to a light emitting source of each of the plurality of emitting means.

14. The system according to claim 11, wherein the emission identifying means is further for determining priorities of the plurality of emitting means.

15. The system according to claim 1, wherein the system further comprises an auxiliary information acquiring means for acquiring auxiliary information corresponding to the imaging information based on the imaging information of the control signal in the camera unit, wherein the controlling means is for determining the control instruction corresponding to the location information and the auxiliary information, so as to control the controlled device corresponding to the remote control system.

16. The system according to claim 1, wherein the light-emitting mode for the light-emitting source to send the control signal comprises at least one of the following items:
shape;
wavelength;
flicker frequency;
brightness;
brightness distribution.

17. The system according to claim 1 , wherein the light-emitting source sends the control signal in an alternative light emitting mode, wherein the alternative light emitting mode comprises at least one of the following items:
a light emitting mode with bright-dark alternative variation;
a light emitting mode with wavelength alternative variation;
a light emitting mode with light spot geometrical feature variation.

18. The system according to claim 1, wherein the detecting means comprises a plurality of camera units for acquiring imaging information of the control signal, respectively, wherein the computing means is for determining location information of the emitting means based on the plurality of pieces of imaging information acquired by the plurality of camera units.

19. The system according to claim 1, wherein the system further comprises a feedback means for sending to the emitting means feedback information corresponding to the control signal, wherein the emitting means further comprises:
receiving unit for receiving the feedback information;
executing unit for executing an operation corresponding to the feedback information based on the feedback information.

20. The system according to claim 19, wherein the executing unit is for:
adjusting brightness control information of the light emitting source based on distance information and/or brightness information of the imaging information as comprised in the feedback information.

21. The system according to claim 1, wherein the emitting means further comprises:
instruction acquiring unit for acquiring instruction information that a user intends to send through the emitting means;
emission control modulation unit for controlling the light-emitting source based on the instruction information to send the control signal at a certain flicker frequency, wherein brightness variation of the control signal corresponds to the instruction information;
wherein, the camera unit obtains the imaging information and the brightness variation at an exposure frequency at least twice of the flicker frequency;
wherein, the controlling means is for determining the control instruction based on the location information and the brightness variation so as to control the controlled device corresponding to the remote control system.

22. The system according to claim 1, wherein the emitting means further comprises:
instruction acquiring unit for acquiring instruction information that a user intends to send through the emitting means;
instruction sending unit for sending an instruction signal corresponding to the instruction information based on the instruction information;
wherein, the system further comprises:
instruction receiving means for receiving an instruction signal from the emitting means;
wherein, the controlling means is for determining the control instruction corresponding to the location information and the instruction signal, so as to control the controlled device connected to the system.

23. The system according to claim 1, wherein the emitting means further comprises a switch unit for performing switch control and/or brightness tuning to the light-emitting source, and for performing switch operation and/or brightness tuning on the emitting means based on an operation of the user.

24. The system according to claim 23, wherein the switch unit comprises a touch key switching unit for performing a corresponding operation on the emitting means based on the user's pressing or raising or touch operation.

25. The system according to claim 1, wherein the system further comprises a state switching trigger means for detecting whether a sleep trigger condition for switching the system into a sleep mode is satisfied; wherein the detecting means is for:
performing a sleep backend operation when the sleep trigger condition is satisfied.

26. The system according to claim 25, wherein the sleep backend operation comprises adjusting an exposure frequency of the camera unit; wherein, the detecting means is for:
acquiring imaging information of the control signal in the camera unit based on the adjusted exposure frequency.

27. The method according to claim 25, wherein the state switching trigger means is further for detecting whether a ready trigger condition for switching the system into a ready mode is satisfied; wherein the detecting means is further for:
when the ready trigger condition is satisfied, entering into a working mode corresponding to the ready trigger condition.

28. The system according to claim 1, wherein the location information comprises three-dimensional location information, wherein the computing means further comprises:
light spot detecting unit for detecting an input light spot corresponding to the emitting means based on imaging information acquired by the detecting means;
three-dimensional computing unit for computing three-dimensional location information of the emitting means based on light spot attribute information of the input light spot.

29. The system according to claim 28, wherein the three-dimensional location information comprises three-dimensional rotary location information.

30. The system according to claim 29, wherein the controlling means is for determining the control instruction corresponding to the three-dimensional rotary location information, so as to control the controlled device connected to the system.

31. The system according to claim 1, wherein the emitting means further comprises a spacing unit that is located at an external periphery of the light-emitting source, wherein a part of the spacing unit facing towards the camera unit is in a dark color or covered with a light absorbing material.

32. The system according to claim 1, wherein the controlled device comprises one or more of a TV set, a set-top-box, a mobile device, a gaming machine, or a PC.
